(19) United States
(12) Patent Application Publication
(10) Pub. No.: US 2005/0042066 A1
(43) Pub. Date: Feb. 24, 2005

(54) Low ground pressure skid for carrying heavy

(76) Inventor: LaVar M. Grover, Idaho Falls, ID (US)

Correspondence Address: Douglas M. Grover;PatentLogix LLC, 157 North Clark Ln, Elk Ridge, UT, 84651, US

(21) Appl. No.: 10/645,390

(22) Filed: Aug. 21, 2003

(51) Int. Cl. B60P 1/04

(52) U.S. Cl. 414/482

(57) ABSTRACT

This invention allows users to carry heavy loads across swamps, marshes, and wetlands without getting bogged down due to the skids low ground pressure design. Traditional dump beds and flat beds can be mounted to the skid for hauling a variety of material. The skid can be hooked to existing tractors, crawler tractors and the like via a three point hitch or a quick hitch. Since a vehicle is required to move the skid, the cost is less than many other alternatives while allowing heavier loads to be carried.

### BACKGROUND OF THE INVENTION

1. Field of the Invention

This invention relates to low ground pressure devices. More specifically, this invention relates to low ground pressure devices for carrying heavy loads.

2. Description of Related Art

A variety of low ground pressure vehicles and devices are used to move material in areas such as marshes or swamps. Typically, such devices or vehicles are expensive, can carry relatively small loads and may not interoperate with traditional equipment. Although these references may not constitute prior art, for general background material, the reader is directed to the following United States Patent and Patent Application Numbers, each of which is hereby incorporated by reference in its entirety for the material contained therein: U.S. patent and Patent Application Nos.: 2002/0155765, U.S. Pat. Nos. 5,984,032, 5,845,595, 5,839,802, 5,727,494, 5,318,141, 4,727,949, 4,645,023, 4,635,740, 4,497,257, 4,355,584, 4,362,340, 4,154,188, 4,072,203.

### SUMMARY OF THE INVENTION

It is desirable to provide a low ground pressure skid for hauling heavy loads across swamps, marshes, and the like where traditional vehicles are unable to cross.

Therefore it is a general object of this invention to provide low ground pressure skid for hauling heavy loads.

It is a further object of an embodiment of this invention to provide a low ground pressure skid for hauling heavy loads which has an adjustable tongue.

It is a further object of an embodiment of this invention to provide a low ground pressure skid for hauling heavy loads which has an end dump bed.

It is a further object of an embodiment of this invention to provide a low ground pressure skid for hauling heavy loads which has a side dump bed.

It is a further object of an embodiment of this invention to provide a low ground pressure skid for hauling heavy loads which has a flat bed.

It is a further object of an embodiment of this invention to provide a low ground pressure skid for hauling heavy loads which has one or more hooks for sliding the rear of the skid.

It is a further object of an embodiment of this invention to provide a low ground pressure skid for hauling heavy loads which has a retractable wheel unit for hauling the skid on a road.

It is a further object of an embodiment of this invention to provide a low ground pressure skid for hauling heavy loads which has a connector to allow the skid to be connected to a vehicle with a three point hitch, a quick hitch or various other types of hitch or connecting assemblies.

It is a further object of an embodiment of this invention to provide a low ground pressure skid for hauling heavy loads which has angled or curved outside walls.

It is a further object of an embodiment of this invention to provide a low ground pressure skid for hauling heavy loads where the frame of the skid is rectangular, square, oval, or circular.

These and other objects of this invention will be readily apparent to those of ordinary skill in the art upon review of the following drawings, detailed description, and claims. In the present preferred embodiment of this invention, the low ground pressure skid makes use of a novel bed and skid combination to allow the ability for hauling heavy loads across swamps, wetlands and other areas where low ground pressure is required.

### BRIEF DESCRIPTION OF THE DRAWINGS

In order to show the manner that the above recited and other advantages and objects of the invention are obtained, a more particular description of the present preferred embodiments of this invention, which are illustrated in the appended drawings, is described as follows. The reader should understand that the drawings depict only present preferred and best mode embodiments of the invention, and are not to be considered as limiting in scope. A brief description of the drawings is as follows:

FIG. 1 is a top view of the present preferred rectangular skid with curved outside walls.

FIG. 2 is a side view of the present preferred rectangular skid with curved outside walls.

FIG. 3 is a cross sectional front view of the present preferred rectangular skid with curved outside walls.

FIG. 4 is a top view of the present preferred rectangular skid with angled outside walls.

FIG. 5 is a side view of the present preferred rectangular skid with angled outside walls.

FIG. 6 is a cross sectional front view of the present preferred rectangular skid with angled outside walls.

FIG. 7 is a top view of the present preferred oval skid with a curved outside wall.

FIG. 8 is a side view of the present preferred oval skid with a curved outside wall.

FIG. 9 is a cross sectional front view of the present preferred oval skid with a curved outside wall.

FIG. 10 is a top view of the present preferred circular skid with a curved outside wall with a tongue connected to the base panel.

FIG. 11 is a side view of the present preferred circular skid with a curved outside wall with a tongue connected to the base panel.

FIG. 12 is a cross sectional front view of the present preferred circular skid with a curved outside wall with a tongue connected to the base panel.

FIG. 13 is a diagram of the present preferred rectangular skid with a mounted dump bed with a tongue connected to the base panel.

FIG. 14 is a cross sectional side view of the present preferred rectangular skid with a mounted flat bed attached to the base panel and the tongue connected to the flat bed.

FIG. 15 is a diagram of the present preferred adjustable tongue assembly.

FIG. 16 is a side view of a three point hitch connector which connects into a three point hitch.

FIG. 17 is a rear view of a three point hitch connector which connects into a three point hitch.

FIG. 18 is a side view of a quick hitch connector which connects to a vehicle with a quick hitch.

FIG. 19 is a rear view of a quick hitch connector which connects to a vehicle with a quick hitch.

FIG. 20 is a side view of a flat bed skid with a retractable wheel unit.

FIG. 21 is a cross sectional view of the present preferred rectangular skid with a side dump bed.

Reference will now be made in detail to the present preferred embodiments of the invention, examples of which are illustrated in the accompanying drawings.

### DETAILED DESCRIPTION

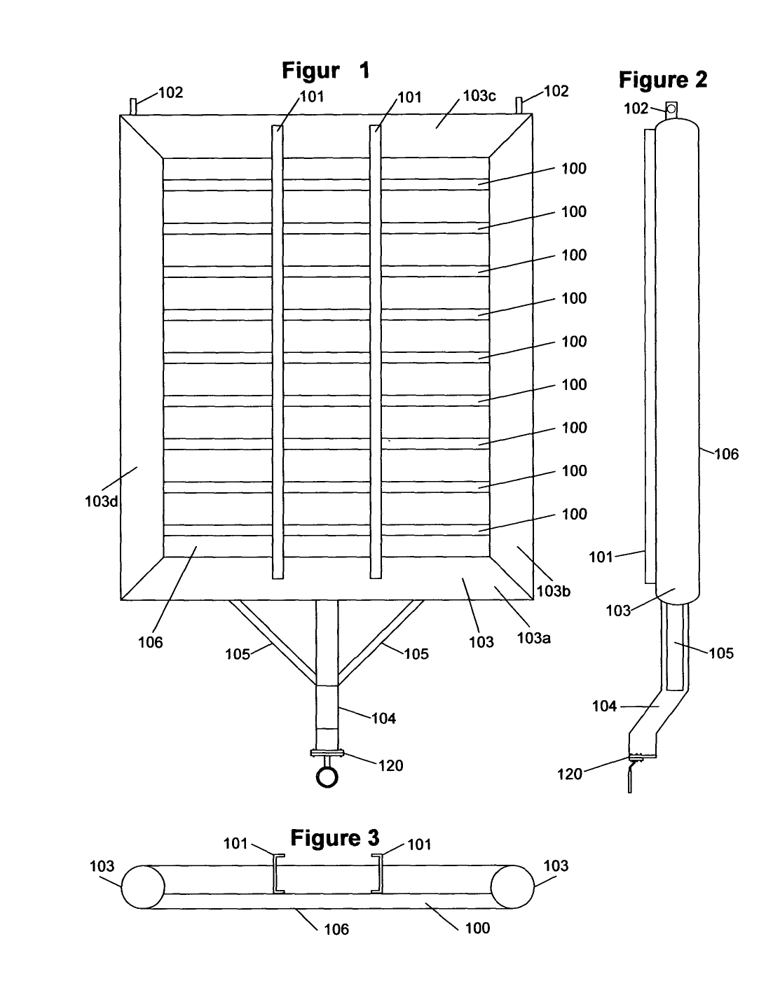

FIG. 1 is a top view of the present preferred rectangular skid with curved outside walls while FIG. 2 is a side view of the present preferred rectangular skid with curved outside walls and FIG. 3 is a cross sectional front view of the present preferred rectangular skid with curved outside walls. Curved outside walls 103a, 103b, 103c, and 103d are connected together to form the rectangular frame 103. The curved walls 103a, 103b, 103c, 103d are curved to allow the skid to be easily pulled or pushed across marshy, swampy and uneven ground. If the walls 103a, 103b, 103c, 103d were not curved or angled, it would make moving the skid more difficult, but not impossible. When the skid is connected to a vehicle with a three point hitch the vehicle can lift the front end of the skid so the skid can slide over obstacles. The disadvantage to non-angled or curved walls 103a, 103b, 103c, 103d, is that the weight of the skid and the skids load would not spread out as much on the base panel 106 when the front of the skid is lifted up using the three point hitch. If the skid is not lifted up, the non-angled or curved walls 103a, 103b, 103c, 103d would catch on the ground and other obstacles such as bushes and the like. The four curved walls 103a, 103b, 103c, 103d are also connected together by a base panel 106. The base panel 106 is further reinforced by base supports 100 which are connected to the rectangular frame 103 and the base panel 106 to give added strength to the skid. The base supports 100 are not necessary if the base panel 106 and rectangular frame 103 are strong enough to support the loads being carried by the skid. A pair of bed supports 101 are connected to the base supports 100 and the frame walls 103a, 103c. The bed supports 101 can be connected only to the frame walls 103a, 103b, 103c, or 103d or only to the base panel 106 or the bed supports can be the rectangular frame 103 if the material used is strong enough to support the loads being carried. Only a single bed support 101 is necessary if the bed support 101 is wide enough to support a bed 111, 813 properly. A tongue 104 is connected to the rectangular frame 103 and to the adjustable tongue assembly 120 to allow a vehicle to pull the skid. The tongue 104 can be connected to the rectangular frame 103, or the tongue 104 can be connected to the base panel 106 or the tongue 104 can be connected to the bed supports 101 as long as it allows the skid to be pulled or pushed. The tongue supports 105 are used to reinforce the tongue 104, but are not necessary if the tongue 104 is strong enough to pull the loads being carried. The sliding hooks 102 are connected to the frame 103 to allow the skid to be pulled by a vehicle when the skid becomes stuck or there is a need pull the back end or side of the skid. The sliding hooks 102 can also be connected to one or either of the bed supports 201.

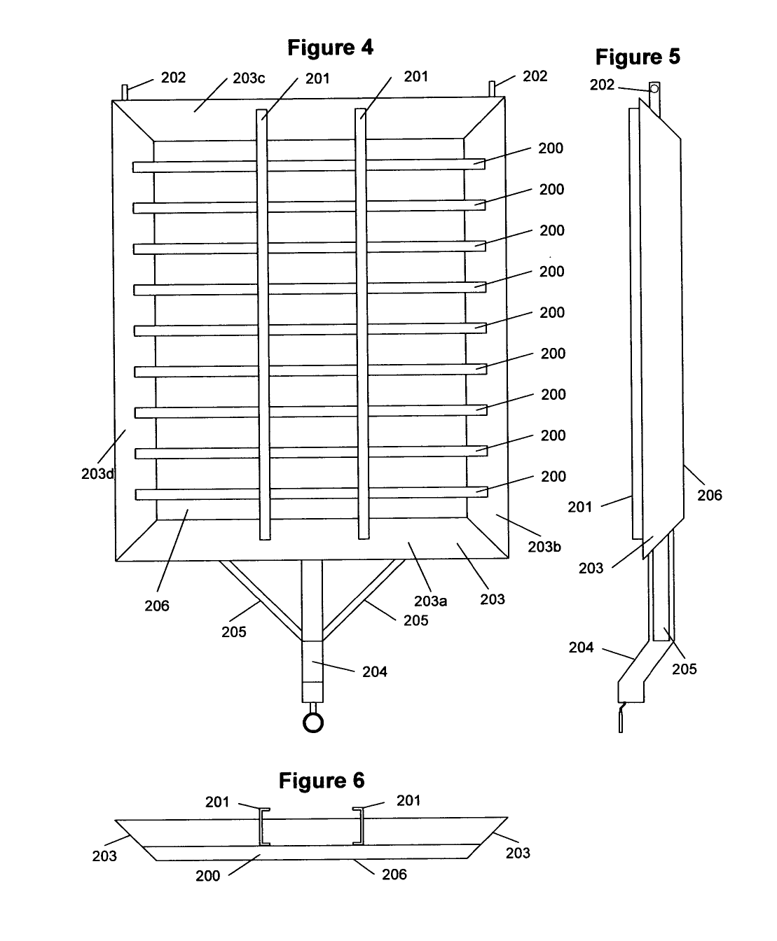

FIG. 4 is a top view of the present preferred rectangular skid with angled outside walls while FIG. 5 is a side view of the present preferred rectangular skid with angled outside walls and FIG. 6 is a cross sectional front view of the present preferred rectangular skid with angled outside walls. Angled outside walls 203a, 203b, 203c, and 203d are connected together to form the frame 203. The curved walls 203a, 203b, 203c, 203d are angled to allow the skid to be easily pulled or pushed across marshy, swampy and uneven ground. The four angled walls 203a, 203b, 203c, 203d are also connected together by a base panel 206. The base panel 206 is further reinforced by base supports 200 which are connected to the frame 203 and the base panel 206 to give added strength to the skid. The base supports 200 are not necessary if the base panel 206 and frame 203 are strong enough to support the loads being carried by the skid. A pair of bed supports 201 are connected to the base supports 200 and the frame walls 203a, 203c. The bed supports 201 are connected to the frame walls 203a, 203c and the base supports 200. The bed supports 201 can be connected only to the frame walls 203a, 203b, 203c, or 203d or only to the base panel 206 or the bed supports can be the frame 203 if the material used is strong enough to support the loads being carried. Only a single bed support 201 is necessary if the bed support 201 is wide enough to support a bed 111, 813, 900 properly. A tongue 204 is connected to the frame 203 to allow a vehicle to pull the skid. The tongue 204 can be connected to the frame 203, or the tongue 204 can be connected to the base panel 206 or the tongue 204 can be connected to the bed supports 201 as long as it allows the skid to be pulled or pushed. The tongue supports 205 are used to reinforce the tongue 204, but are not necessary if the tongue 204 is strong enough to pull the loads being carried. The sliding hooks 202 are connected to the frame 203 to allow the skid to be pulled by a vehicle when the skid becomes stuck or there is a need pull the back end or side of the skid. The sliding hooks 202 can also be connected to one or either of the bed supports 201.

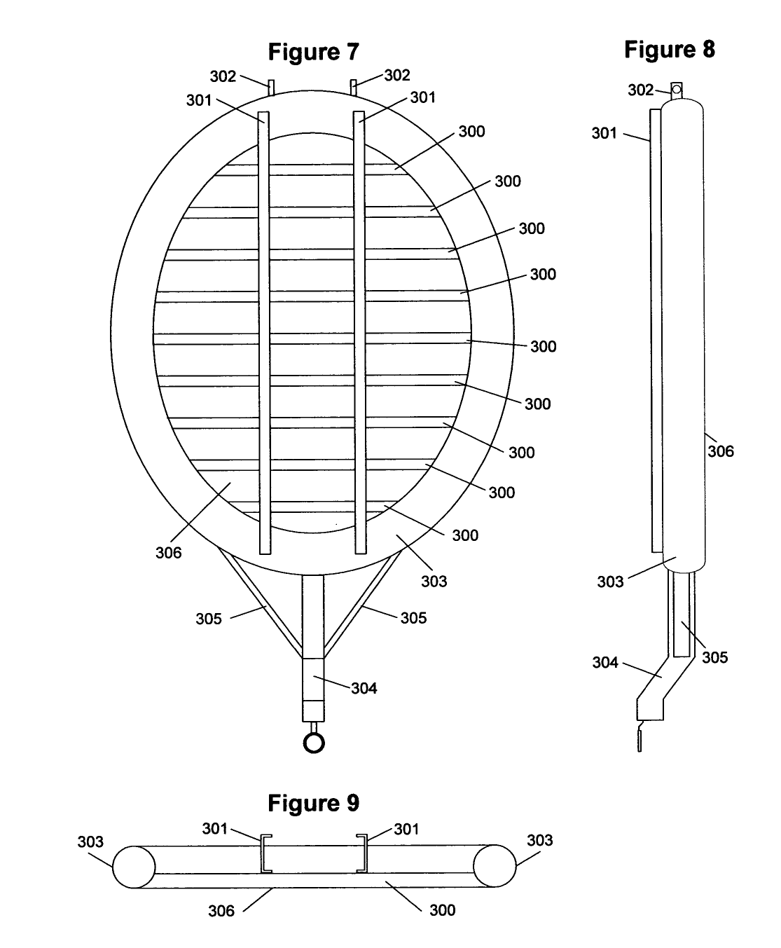

FIG. 7 is a top view of the present preferred oval skid with a curved outside wall while FIG. 8 is a side view of the present preferred oval skid with a curved outside wall and FIG. 9 is a cross sectional front view of the present preferred oval skid with a curved outside wall. An oval frame 303 with angled or curved sides allows the skid to be easily pulled or pushed across marshy, swampy and uneven ground. The oval frame 303 is connected along the bottom by a base panel 306. The base panel 306 is further reinforced by base supports 300 which are connected to the oval frame 303 and the base panel 306 to give added strength to the skid. The base supports 300 are not necessary if the base panel 306 and oval frame 303 are strong enough to support the loads being carried by the skid. A pair of bed supports 301 are connected to the base supports 300 and the oval frame 303. The bed supports 301 are connected to the oval frame 303 and the base supports 300. The bed supports 301 can be connected only to the oval frame 303 or only to the base panel 306 or the bed supports can be the oval frame 303 if the material used is strong enough to support the loads being carried. Only a single bed support 301 is necessary if the bed support 301 is wide enough to support a bed 111, 813 properly. A tongue 304 is connected to the oval frame 303 to allow a vehicle to pull the skid. The tongue 304 can be connected to the oval frame 303, or the tongue 304 can be connected to the base panel 306 or the tongue 304 can be connected to the bed supports 301 as long as it allows the skid to be pulled or pushed. The tongue supports 305 are used to reinforce the tongue 304, but are not necessary if the tongue 304 is strong enough to pull the loads being carried. The sliding hooks 302 are connected to the oval frame 303 to allow the skid to be pulled by a vehicle when the skid becomes stuck or there is a need pull the back end or side of the skid. The sliding hooks 302 can also be connected to one or either of the bed supports 301.

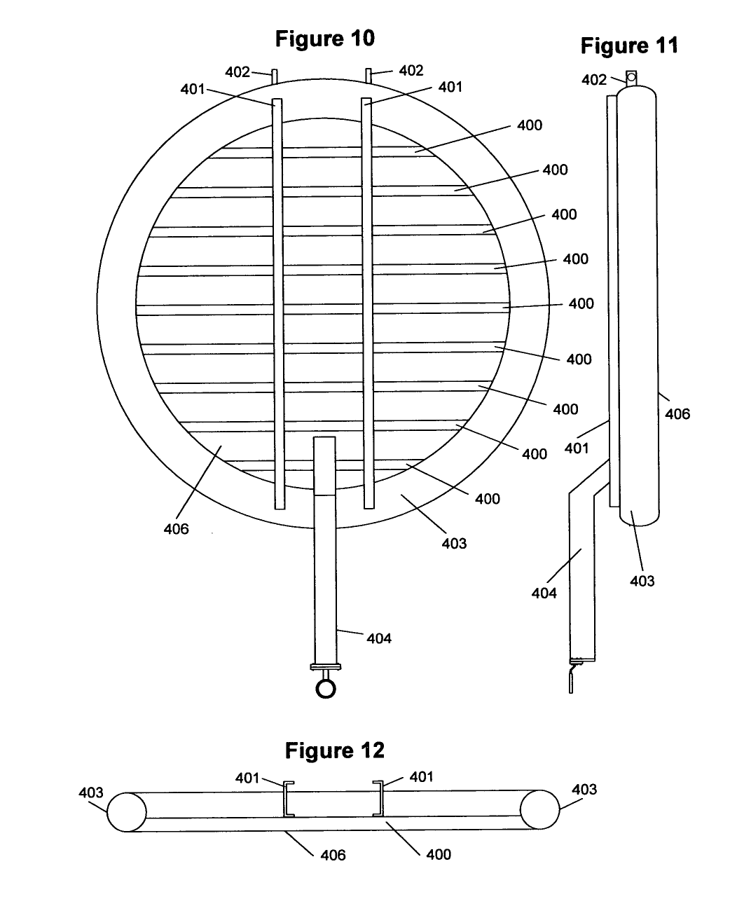

FIG. 10 is a top view of the present preferred circular skid with a curved outside wall with the tongue connected to the base panel while FIG. 11 is a side view of the present preferred circular skid with a curved outside wall with the tongue connected to the base panel and FIG. 12 is a cross sectional front view of the present preferred circular skid with a curved outside wall with the tongue connected to the base panel. A circular frame 403 with angled or curved sides allows the skid to be easily pulled or pushed across marshy, swampy and uneven ground. The circular frame 403 is connected along the bottom by a base panel 406. The base panel 406 is further reinforced by base supports 400 which are connected to the circular frame 403 and the base panel 406 to give added strength to the skid. The base supports 400 are not necessary if the base panel 406 and circular frame 403 are strong enough to support the loads being carried by the skid. A pair of bed supports 401 are connected to the base supports 400 and the circular frame 403. The bed supports 401 are connected to the circular frame 403 and the base supports 400. The bed supports 401 can be connected only to the circular frame 403 or only to the base panel 406 or the bed supports can be the circular frame 403 if the material used is strong enough to support the loads being carried. Only a single bed support 401 is necessary if the bed support 401 is wide enough to support a bed 111, 813, 900 properly. A tongue 404 is connected to the base panel 406 to allow a vehicle to pull the skid. The tongue 404 can be connected to the circular frame 403, or the tongue 404 can be connected to the base panel 406 or the tongue 404 can be connected to the bed supports 401 as long as it allows the skid to be pulled or pushed. The tongue supports 405 are used to reinforce the tongue 404, but are not necessary if the tongue 404 is strong enough to pull the loads being carried. The sliding hooks 402 are connected to the circular frame 403 to allow the skid to be pulled by a vehicle, winch, or the like when the skid becomes stuck or there is a need pull the back end of the skid. The sliding hooks 402 can also be connected to one or either of the bed supports 401.

FIG. 13 is a diagram of the present preferred rectangular skid with a mounted end dump bed 111. An end dump bed 111 is connected to the skid by a connecting pin 114 which connects the end dump bed 111 to the bed supports 101. The end dump bed 111 is also connected to the frame 103 or the bed supports 101 by a hydraulic ram 110 that is used to raise and lower the end dump bed 111. The hydraulic ram 110 is connected to the vehicle which pulls the skid. Loads of material are placed in the end dump bed 111 to be transported and later dumped. The end dump bed 111 has a tail gate 112 which is opened when the load of material is dumped. A side dump bed that dumps material from the side rather than the end can also be used. Side dump beds and end dump beds 111 are commonly used on trucks for hauling material.

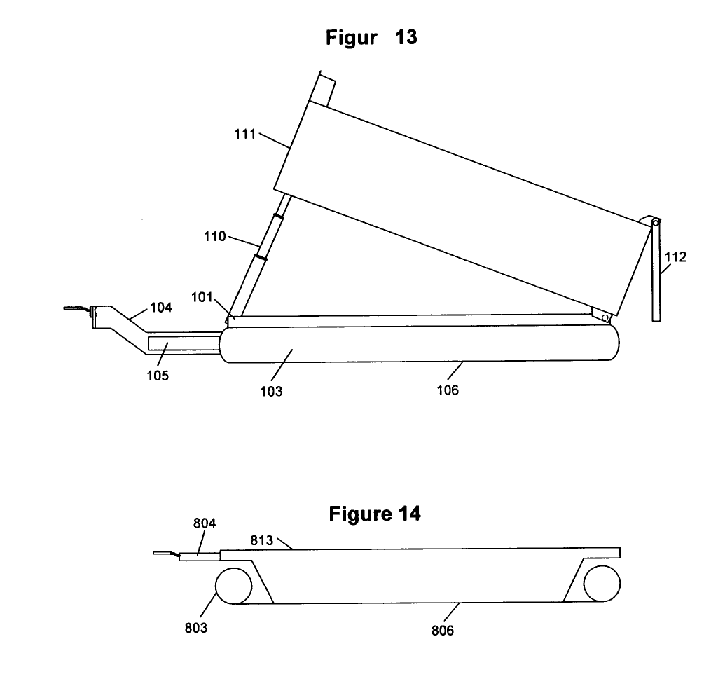

FIG. 14 is a cross sectional side view of the present preferred rectangular skid with a mounted flat bed 813 attached to the base panel 806 and the tongue 804 is connected to the flat bed. The frame 803 is connected to the base panel 806. This allows material to be loaded on to the flat bed 813 and transported using the skid.

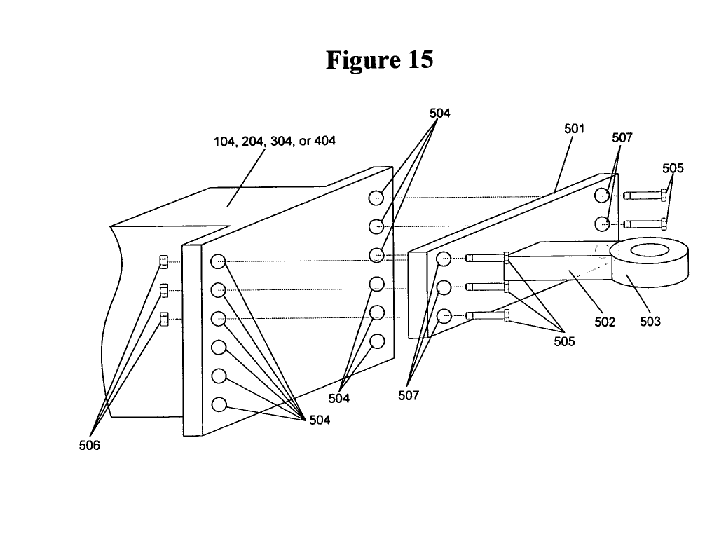

FIG. 15 is a diagram of the present preferred adjustable tongue assembly 120. The adjustable tongue assembly 120 allows the user to adjust the height of the lunette ring 503 to match the height of the vehicle which is pulling the skid. A tongue 104, 204, 304, 404 which has an adjustable tongue assemble 120 has a set of tongue holes 504 which are used to mount the adjustable tongue 501. The adjustable tongue 501 has a set of adjustable tongue holes 507 which line up with the tongue holes 504. The adjustable tongue 501 can be moved up or down and secured using the bolts 505 which go through each adjustable tongue hole 507 and the corresponding tongue hole 504. The each bolt 505 is secured with a corresponding nut 506. The adjustable tongue is connected to a tongue bar 502 which in turn is connected to a lunette ring 503. The lunette ring 503 connects to the vehicle which pulls or pushes the skid.

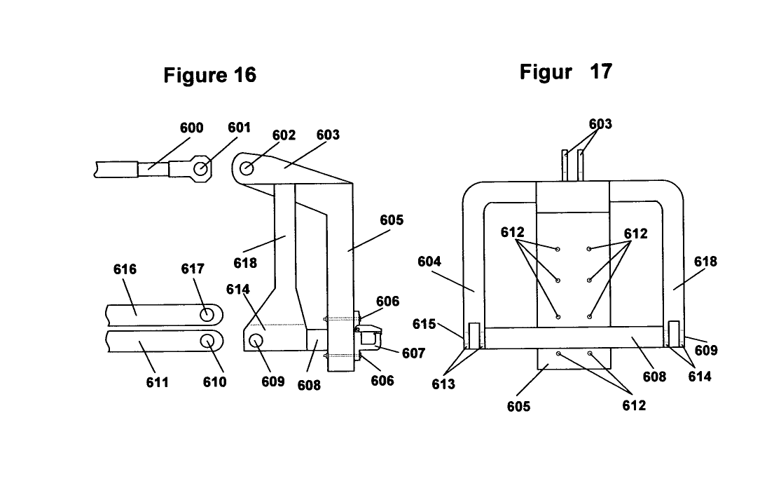

FIG. 16 is a side view of a three point hitch connector which connects into a three point hitch while FIG. 17 is a rear view of a three point hitch connector which connects into a three point hitch. A three point hitch has three connecting arms which allow the three point hitch to connect to various types of equipment. The upper three point hitch connecting arm 600 along with a pair of lower three point hitch connecting arms 611, 616 connect to the three point hitch connector by sliding into the upper connection piece 603 and the lower connection pieces 613 and 614. A bolt or pin is placed through the upper connection hole 602 and the upper three point hitch hole 601 and a second pin is placed through the lower connection hole 609 and the lower three point hitch hole 610. A third pin or bolt is placed through the lower connection hole 615 and the lower three point hitch hole 617 to secure the three point hitch connector. The upper connection hole 602 goes through both of the pieces of the upper connection piece 603. The upper connection piece 603 is connected to the pintle hook support 605. The pintle hook 607 is connected to the pintle hook support 605 by four connecting bolts 606 which go through the pintle hook adjustment holes 612. This allows the pintle hook 607 to be moved up and down to match the height of the equipment being connected to the pintle hook 607. The side supports 604, 618 connect to pintle hook support 605 and the lower connection pieces 613, 614. The lower connection pieces 613, 614 connect to the support bar 608 which connects to pintle hook support 605.

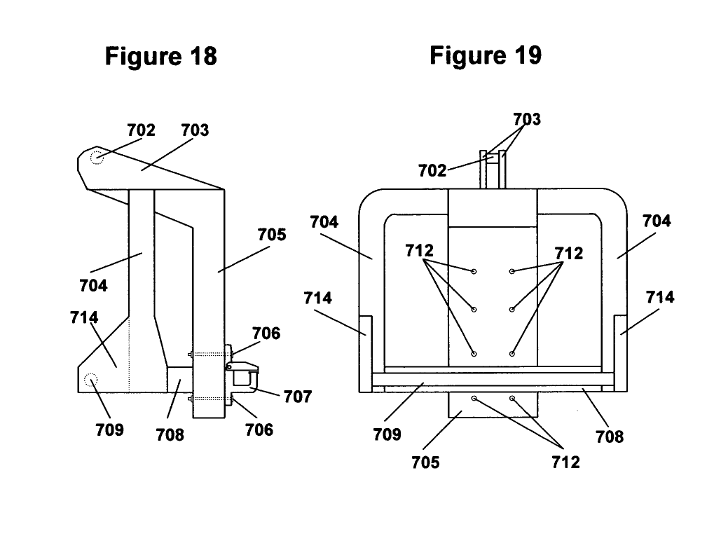

FIG. 18 is a side view of a quick hitch connector and FIG. 19 is a rear view of a quick hitch connector which connects to a vehicle with a quick hitch. A quick hitch has three connecting hooks which allow the quick hitch to connect to various types of equipment. The two lower hooks on the quick hitch hook around the lower quick hitch bar 709 while the upper hook on the quick hitch hooks around the upper quick hitch bar 702. The quick hitch connector is locked in place by locks on the quick hitch. The upper quick hitch bar 702 is supported by two upper quick hitch bar supports 703 which are connected to the pintle hook support 705. The pintle hook 707 is connected to the pintle hook support 705 by four connecting bolts 706 which go through the pintle hook adjustment holes 712. This allows the pintle hook 707 to be moved up and down to match the height of the equipment being connected to the pintle hook 707. The side supports 704 connect to pintle hook support 705 and the lower quick hitch bar supports 714. The lower quick hitch bar supports 714 are connected to the lower quick hitch bar 709. The support bar 708 connects the pintle hook support 705 to the side supports 704.

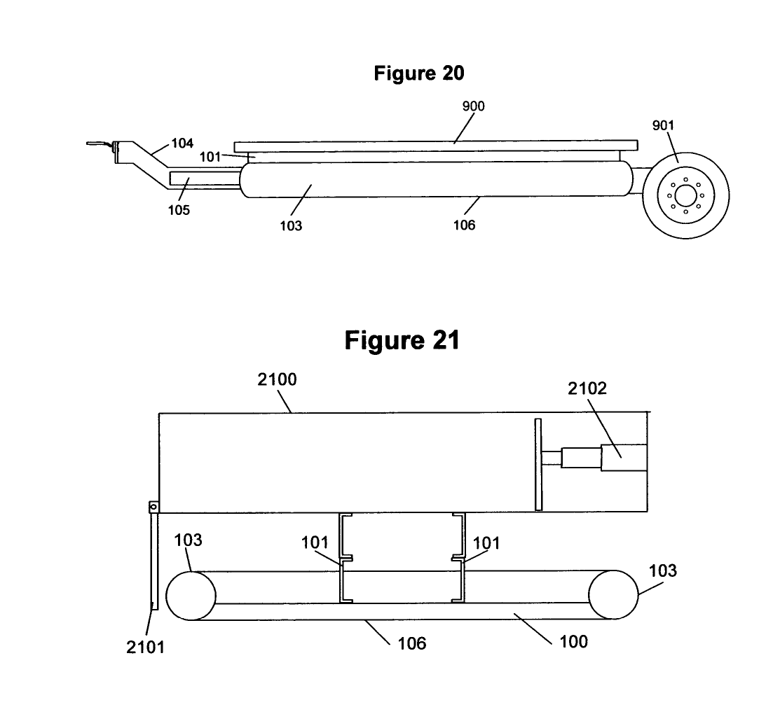

FIG. 20 is a side view of a flat bed 900 skid with a retractable wheel unit 901. The retractable wheel unit 901 can be raised when the skid is being used to carry loads. The retractable wheel unit 901 can be lowered so the skid can be transported on a road. Retractable wheel units are commonly used on trucks. U.S. Pat. Nos. 5,727,494, 4,497,257, and 4,355,584 show vehicles with retractable wheel units used in similar applications.

FIG. 21 is a cross sectional view of the present preferred rectangular skid with a side dump bed. A side dump bed 2100 is mounted on the bed supports 101. The side dump bed 2100 has a gate 2101 which opens allowing material to dumped from the side of the skid. The material is pushed out of the side dump bed 2100 with a hydraulic ram 2102. This skid can be connected to various types of vehicles such as tractors, crawler tractors and the like using various types of connectors, hitches, and the like. In addition, the skid can be build using a variety of materials such as metal or other materials capable of carrying heavy loads.

The described embodiments of this invention are to be considered in all respects only as illustrative and not as restrictive. Although specific diagrams are provided, the invention is not limited thereto. The scope of this invention is, therefore, indicated by the claims rather than the foregoing description. All changes, which come within the meaning and range of equivalency of the claims, are to be embraced within their scope.

1. A low ground pressure skid for carrying heavy loads comprising:
A. a frame said frame having a bottom;
B. a base panel connected to said bottom of said frame;
C. wherein said frame and said base panel reduce pressure and allow the skid to be moved;
D. a bed having a bed connection point;
E. wherein said bed connection point is connected to one of the items selected from the group consisting of said frame and said base panel;
F. a tongue having a tongue connection point; and
G. wherein said tongue connection point is connected to one of the items selected from the group consisting of said frame, said base panel, and said bed.

2. A low ground pressure skid as recited in claim 1 wherein said tongue is an adjustable tongue.

3. A low ground pressure skid as recited in claim 1 wherein said bed is a dump bed.

4. A low ground pressure skid as recited in claim 3 wherein said dump bed is an end dump bed.

5. A low ground pressure skid as recited in claim 3 wherein said dump bed is a side dump bed.

6. A low ground pressure skid as recited in claim 1 wherein said bed is a flat bed.

7. A low ground pressure skid as recited in claim 1 further comprising a sliding hook.

8. A low ground pressure skid as recited in claim 1 further comprising a retractable wheel unit.

9. A low ground pressure skid as recited in claim 1 further comprising a three point hitch connector.

10. A low ground pressure skid as recited in claim 1 further comprising a quick hitch connector.

11. A low ground pressure skid as recited in claim 1 wherein said frame's outside wall is angled.

12. A low ground pressure skid as recited in claim 1 wherein said frame's outside wall is curved.

13. A low ground pressure skid as recited in claim 1 wherein said frame is rectangular.

14. A low ground pressure skid as recited in claim 1 wherein said frame is oval.

15. A low ground pressure skid as recited in claim 1 wherein said frame is circular.

16. A low ground pressure skid as recited in claim 1 wherein said frame is square.

17. A low ground pressure skid as recited in claim 1 further comprising one or more base supports.

18. A low ground pressure skid as recited in claim 1 further comprising one or more bed supports.

19. A low ground pressure skid for carrying heavy loads comprising:
A. a frame said frame having a bottom;
B. a base panel connected to said bottom of said frame;
C. wherein said frame and said base panel reduce pressure and allow the skid to be moved;
D. one or more base supports connected to said frame and said base panel;
E. one or more bed supports connected to said frame and said base supports;
F. a bed connected to said one or more bed supports; and
G. a tongue having a tongue connection point;
H. wherein said tongue connection point is connected to one of the items selected from the group consisting of said frame, said base panel, and said bed.

20. A low ground pressure skid as recited in claim 19 wherein said tongue is an adjustable tongue.

21. A low ground pressure skid as recited in claim 19 wherein said bed is a dump bed.

22. A low ground pressure skid as recited in claim 21 wherein said dump bed is an end dump bed.

23. A low ground pressure skid as recited in claim 21 wherein said dump bed is a side dump bed.

24. A low ground pressure skid as recited in claim 19 wherein said bed is a flat bed.

25. A low ground pressure skid as recited in claim 19 further comprising a sliding hook.

26. A low ground pressure skid as recited in claim 19 further comprising a retractable wheel unit.

27. A low ground pressure skid as recited in claim 19 further comprising a three point hitch connector.

28. A low ground pressure skid as recited in claim 19 further comprising a quick hitch connector.

29. A low ground pressure skid as recited in claim 19 wherein said frame's outside wall is angled.

30. A low ground pressure skid as recited in claim 19 wherein said frame's outside wall is curved.

31. A low ground pressure skid as recited in claim 19 wherein said frame is rectangular.

32. A low ground pressure skid as recited in claim 19 wherein said frame is oval.

33. A low ground pressure skid as recited in claim 19 wherein said frame is circular.

34. A low ground pressure skid as recited in claim 19 wherein said frame is square.
